(19) United States
(12) Patent Application Publication
(10) Pub. No.: US 2012/0209932 A1
(43) Pub. Date: Aug. 16, 2012

(54) Web HTTP-based real-time computer control

(76) Inventor: Jimmy Kit Lee, San Jose, CA (US)

(21) Appl. No.: 13/026,219

(22) Filed: Feb. 12, 2011

(51) Int. Cl. G06F 15/16

(52) U.S. Cl. 709/208

(57) ABSTRACT

The invention disclosed is a computer system for controlling one or more slaves from a browser-like master program. The computer program receives a http-formatted input in an address bar entry field and performs a result task in the destination slave computer(s), wherein the process set produces a global control mechanism that manages and permits all participating computers to work together as one giant.

### FIELD OF THE INVENTION

The present invention is related to web technologies for managing and controlling computers in an interne. The invention includes subject matter wherein a new concept as well as a concrete implementation is presented to provide and to promote the user community to participate in another grand scheme of exploring the benefits of the internet for daily lives.

### BACKGROUND OF THE INVENTION

Demand-based services had been the commonplace of ripping the power of the internet world in which services are requested by an user going to particular web sites and surfing them. When an user needs something, he or she will generally do a search for a site then get something of value from that site. This request/response methodology is a simple yet powerful foundation that transforms the way we live.

However, the other half of the internet has not yet been tapped. Web sites, instead of passively waiting and then serving requests, can actively control and execute tasks. Users can manage other computers to do work on their behalf, and can multiply many folds their productivity output.

The infrastructure and protocols of the internet has come into existence a while ago and is stable today. Whenever possible, the invention conforms to existing infrastructure, protocols, and web-related functions, including the look-and-feel of familiar functions. Web designers can transfer their learned skills seamlessly into the invention's control site development. In fact, at least in theory, any web page or resource that can be displayed or processed by a browser can also be similarly handled by the master of the invention.

The invention shall follow all the footsteps of the original request/response model responsible for the explosive growth of the internet, in a way to open up a vast untapped potential of the internet itself and to complete the circle of development to full-fill the true and full capability of the internet technology. This shall allow computers to control computers, as if the word is one giant computer.

### SUMMARY OF THE INVENTION

The invention is a computer system for controlling one or more slaves from a browser-like master program. The computer program receives a http-formatted input in an address bar entry field and performs a result task in the destination slave computer(s), wherein the process set produces a global control mechanism that manages and permits all participating computers to work together as one giant.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 illustrates an exemplary network of hardware devices in which the present invention can be practiced;

FIG. 2 is a schematic of a software having components of the present invention created therein;

FIG. 3 is a flowchart of an embodiment of the present invention;

FIG. 4 illustrates an exemplary graphical user interface to the present invention;

FIG. 5 represents a fictional control web resource for the present invention; and

FIGS. 6A & 6B illustrate a hypothetical application of the present invention to a fictional control web resource.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a multi-computer system that manages and controls one or more other computers to implement the novel aspects of the invention. For illustrative purposes, the inventive computer system will be referred to as the “master slave” system.

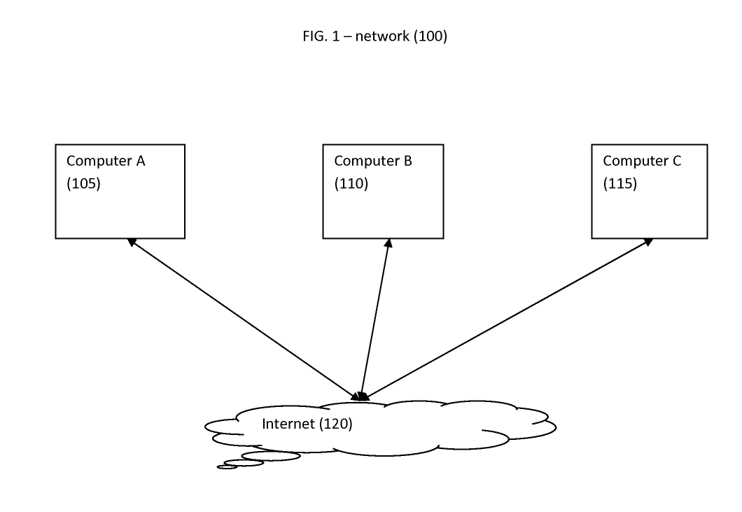

Additionally, the Master Slave Control program is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including master computer 105, slave computer 110, and slave computer 115. Network connection 120 comprises all hardware, software, and communications media necessary to enable communication between network nodes 105-115. Unless otherwise indicated in context below, all network nodes use publicly available protocols or messaging services to communicate with each other through network connection 120.

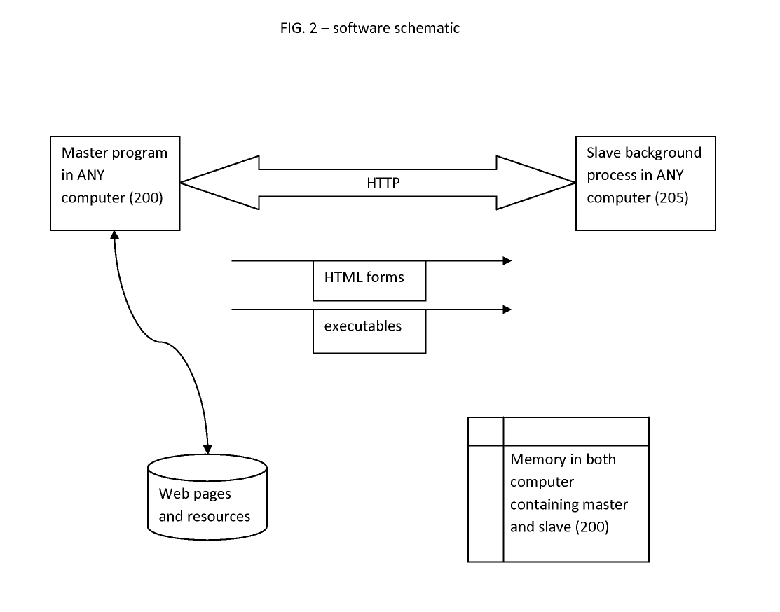

Master Slave Control program 200 and its remote component, slave background process 205, typically are stored in a memory, represented schematically as memory 220 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media and network nodes. Thus, FIG. 2 is included merely as a descriptive expedient and does not necessarily reflect any particular physical embodiment of memory 220. As depicted in FIG. 2, though, memory 220 may include additional data and programs. Of particular import to Master Slave Control program 200, memory 220 may include dedicatedly provided programs, with which Master Slave Control program 200 interacts. Dedicated program 230 represents any end-user customized software that provides an execution module to be launched at the slave machines. Control site 240 represents any web resource (including without limitation a HTML file, a CGI script, a JSP page, or a ASP page, etc.) that contains XML-based or other descriptive languages to display on the master browser-like controller. In practice, the slave programs is managed and controlled by the master programs, but is largely distributed.

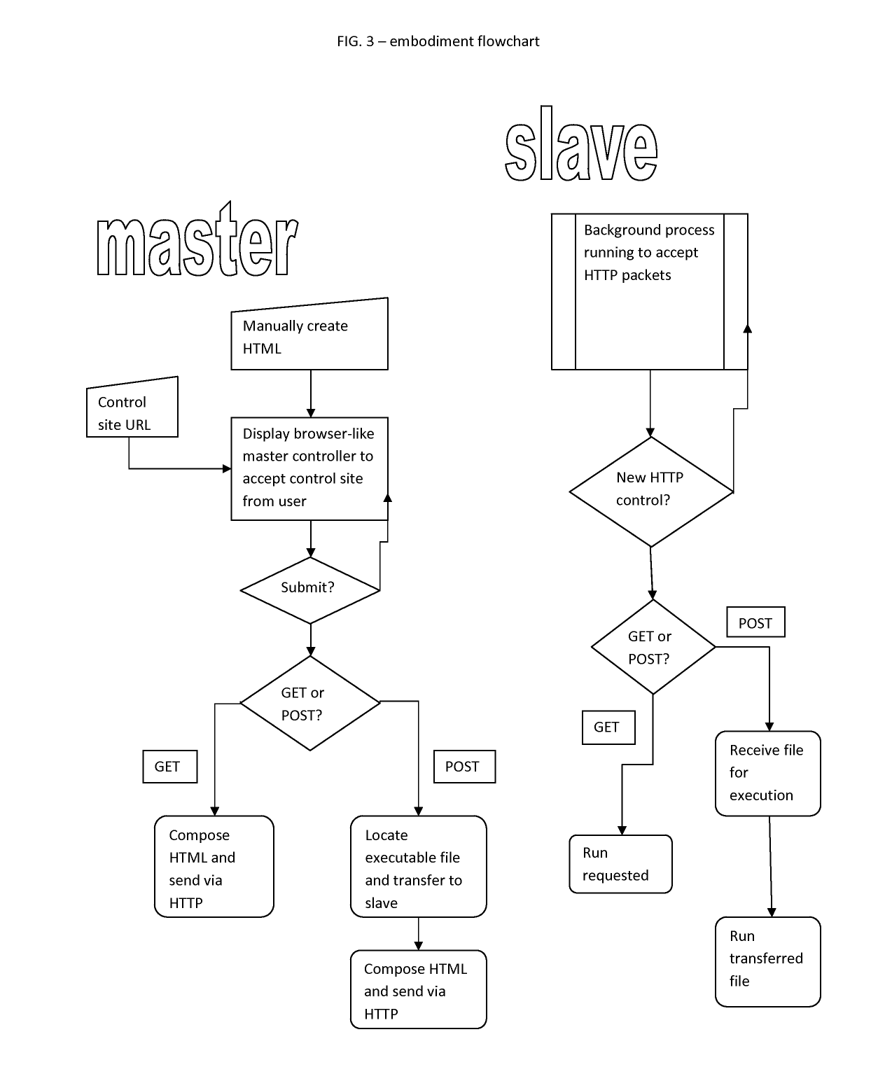

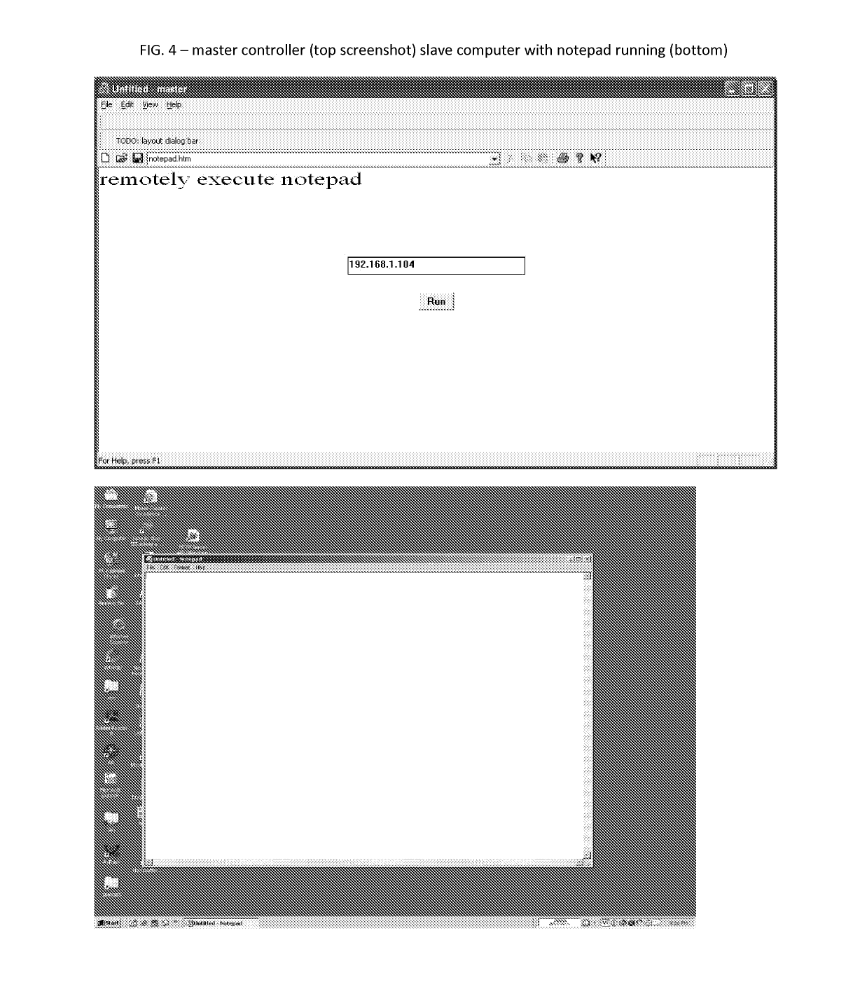

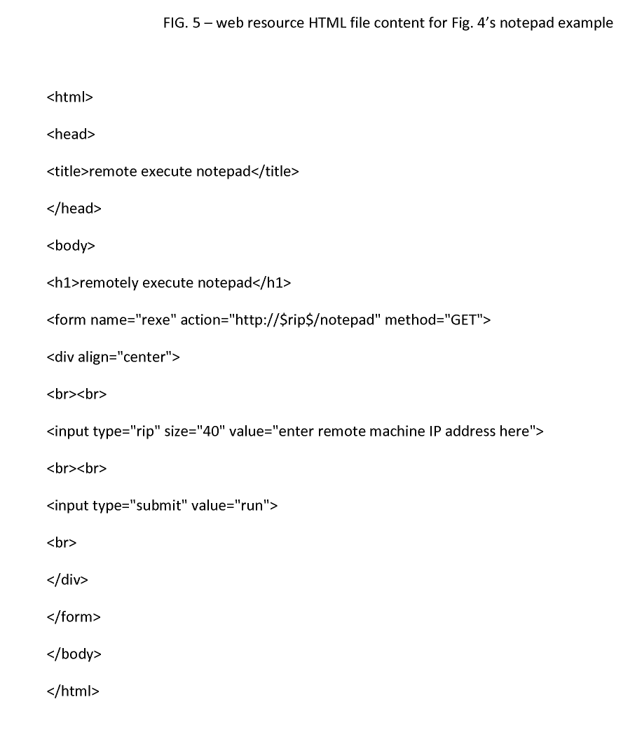

FIG. 3 is a flowchart of Master Slave Control program 200. As indicated in FIG. 3, when a user activates Master Slave Control program 200, the master program prompts the user for a web page to be fetched. Upon user's input of an URL for a web page at the address bar of the master program, the master program reads and interprets the fetched web page. Based upon its interpretation of the XML or similar content of the web page, in a way virtually identical to how an Internet browser like Firefox, Safari or Internet Explorer handles the web page, the program displays the corresponding graphical user interface (302). In fact, the same page normally used by a browser can be reused by the master program. FIG. 4 illustrates an exemplary graphical user interface (GUI) 400, including text entry field 402 and submit button 404. The discussion that follows refers to GUI 400 for descriptive purposes, but complex web page rendering also is compatible with Master Slave Control program 200. After the master program displays the user interface (302), the user can enter any machine name or IF address (304) into text entry field 402, and click the submit button 404. Master Slave Control program 200 then connects to the addressed remote machine entered in text entry field 402 to deliver a HTTP GET/POST method to the slave background process 205 of that machine, for the purpose of causing the slave to perform a certain task. In the embodiment illustrated in FIG. 3, the slave program 205 is engaged to run a specific local program such as “notepad.exe” prescribed via code by the user-selected web page each time the master program sends a new http method containing the identity of such local program, but Master Slave Control program 200 also could deliver and run any arbitrary program regardless of whether or not such program already exists at the slave machine. Here are the detailed steps of the embodiment: The user begins by either drafting or obtaining an already drafted HTML or like page using XML or like syntax; The user goes to that page by entering its URL location at the address bar of the master program; The master program fetches the page and interprets it; The master program displays the page just like what a browser would and could be sharing some or all of the same pages used by a browser, where the difference would be certain enhancements dedicated to provide master control capacities, specifically the HTML form in the embodiment is given an additional semantics that its information is used to command a specific remote task operation “notepad.exe” instead of the customary user data collection purpose, that the form “GET” is used to denote local programs resident in the slave machine, that the form “POST” is used to denote transferred programs from the master machine to the slave machine for execution, and that new tag fields are used to provide additional control parameters; as in the case of this embodiment, where user had entered “notepad.htm” that would have contained within its XML document the following form tag:

<form> . . . <method=“GET”></form>
interpreted by the master program to request the slave program to run “notepad.exe” at the slave machine. Alternatively, the form contained by “notepad.htm”, optionally renamed to say for example “notepad_need_transfer.htm”, may instead contain the following variant form tag:
<form> . . . <method=“POST”></form>
now interpreted by the master program to first transfer an executable file “notepad.htm” or a renamed “notepad_need_transfer.htm” from either the master machine itself or other accessible location to the slave machine and to request the slave program to run the transferred program. The master so messages such and the slave so complies accordingly—by doing the requested task.

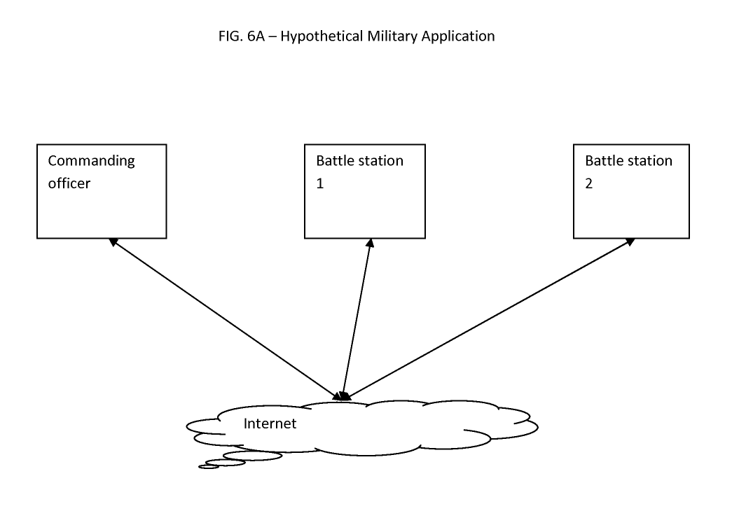

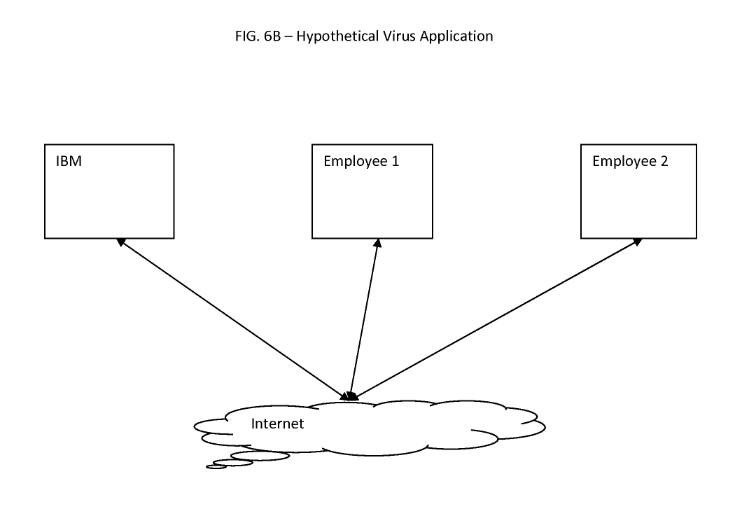

FIGS. 5, 6A, and 6B illustrate these inventive aspects further by demonstrating the practical applications of Master Slave Control program 200 to specific, but fictional, control sites, defined as a system of master machines and slave machines managing web pages and resources.

Fictional control site 500 is presented as a diagram in FIG. 5. In fictional control site 500, each machine is represented either as a master or as a slave comprised of the appropriate software and web pages and resources. In this hypothetical example, a commanding officer may raise the Def Con level of all battle station slave machines to 2. This example simultaneously illustrates two concepts—one showing a new task type that configures a slave machine rather than running a program, another showing a deployment type that involves a military unit. In general, the master program can request or cause the slave program to perform any task that the slave machine is able to do. Another example would be a large corporation such as IBM needing to shutdown all of their employees' computers upon a serious thread of security. A more far-reaching example would be a government entity like IRS needing to audit financial beings at some time when all such information is required to be online. Perhaps, a global virtual control can be implemented as well. Thus, the network of computers can be controlled and managed in giant interconnection scheme 500, giving rise to a grand scheme of computers all working as a single unit under true distributed control. Of course, the user of each slave machine can consciously choose to deny the master access or limit its involvement. In total, the invention provides a mechanism and protocols to allow a user to register for control, or to allow a user to host control sites.

Master Slave Control program 200 may be integrated with existing internet nodes, web resources and client browsers, such as those that allow a user to visit web sites at will, or that allow a user to host web sites from user's own resources and advertise them. Such components nowadays already have countless number of web sites, along with functional servers for processing these web site functions. Such common web servers are illustrated in FIG. 4, labeled as an “Server” component. In such an embodiment, a new control site labeled “Controller” or something similar would be added to the existing architecture, which when deployed would expand the power of the interne to include the control status capability to its preexisting request response one. As the user surfs web sites in the public net, Master Slave Control program 200 enhances the experience of control of other computers through control sites. If desired, the user then can select any of the control sites and accompanied control HTML pages and resources from the world of hosting machines, and Master Slave Control program 200 would automatically carry out the wishes of the user from the master programs and exercise controls remotely from the slave programs, since Master Slave Control program 200 has already all the stuffs.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer system product for performing a method of controlling one or more slave computing entities from a browser-like master controller, the computer system product comprising: a computer program similar to web browsers; first program capability for reading and interpreting an HTML page, or any other advanced web resource file, from the URL location specified by the user via the address bar of the master, wherein the submission of an enhanced HTML form that an action task is to be executed in the slave machine triggers the performance of a remote task of the type indicated by the combined data in both the HTML page and the user-supplied input; second program capability for communicating via the well-known HTTP protocol between the master and the slave machines; third program capability for shipping an executing code file, or any other advanced binary/text file, for the above-mentioned task execution required by the slave via the above-mentioned page/user data, wherein any program can be transferred and executed at the slave; and fourth program capability functioning as a daemon or background services on the slave machine for performing any task as instructed by the master; wherein the first through the fourth program capabilities are coordinated to permit any user to command any task done at remote machines.

2. An unprecedented new concept using claim 1 to control a large set of computers, using familiar HTTP protocols and browser look-and-feel, and forming a foundation for any web designer who may already be familiar with current HTML design rules to reuse them.

3. As the request/response mechanism used in providing all sort of services had revolutionized the world, claim 2 would once again revolutionize it using control/status mechanism described by claim 1.

4. Claim 2 implemented via claim 1 forms a backbone for any corporate or governmental entities to gain complete and full control of their computer systems.

5. Claim 2 implemented via claim 1 shall allow piecemeal and incremental development to enable the evolution and revolution, partly by the virtue of being a concept so generic that any developer may design and customize for specific or dedicated needs.

6. A new operating system designed and implemented from scratch to incorporate claim 2 at the operating system level. Such implementation shall allow fine-grain controls including but not limited to accessing other computers' memory, using other computers' input/output devices, and even running other computers' Central Processing Unit.
